(19) United States
(12) Patent Application Publication
(10) Pub. No.: US 2025/0314219 A1
(43) Pub. Date: Oct. 9, 2025

(54) THRUST REVERSER COMPRISING A SIMPLIFIED-DEPLOYMENT OBTURATOR MEMBRANE

(71) Applicant: SAFRAN NACELLES, Gonfreville-L'Orcher (FR)

(72) Inventors: Francois BELLET, Moissy-Cramayel (FR); Laurent Georges VALLEROY, Moissy-Cramayel (FR)

(73) Assignee: SAFRAN NACELLES, Gonfreville-L'Orcher (FR)

(21) Appl. No.: 18/864,958

(22) PCT Filed: May 16, 2023
(86) PCT No.: PCT/FR2023/050698

§ 371 Date: Nov. 12, 2024

(30) Foreign Application Priority Data
May 20, 2022 (FR) 2204838

(51) Int. Cl. F02K 1/72; B64D 29/00; F02K 1/76

(52) U.S. Cl. CPC F02K 1/72; B64D 29/00; F02K 1/76

(57) ABSTRACT

A thrust reverser for an aircraft propulsion unit, including a fixed structure equipped with a wall for radially internally delimiting a secondary flow duct, and a mobile structure including at least one reverser mobile cowl equipped with a reverser-cowl radially internal wall, the mobile structure being movable between a forward direct-thrust position and a retreated reverse-thrust position, the thrust reverser also including at least one obturator membrane designed to deflect at least some of the secondary flow towards the cascade vanes when the mobile structure is in the retreated reverse-thrust position. The reverser can include a mobile frame for deploying the obturator membrane, this frame being mounted with the ability to pivot on the mobile structure of the reverser between a retracted position and a position in which it is deployed in the secondary flow duct.

### TECHNICAL FIELD

The invention relates to the field of nacelles and thrust reversers for an aircraft propulsion unit, and, more specifically, to thrust reversers equipped with obturator membranes.

### PRIOR ART

Thrust reversers are devices used to deflect the flow of air passing through the propulsion unit towards the front, so as to shorten landing distances and limit the load on the brakes on the landing gear.

The vane reversers currently used in the aeronautical sector comprise cascade vanes integrated into a fixed or mobile structure of the reverser. The mobile structure of the reverser includes one or more reverser mobile cowls, and it is translationally movably mounted in relation to the fixed structure between a forward direct-thrust position, and a retreated reverse-thrust position.

In the retreated reverse-thrust position, in order to deflect at least some of the secondary flow towards the vanes, the reverser is usually equipped with sealing flaps, which, at least partially seal the secondary flow duct when deployed. In a known manner, this forces the air of the secondary flow radially outwards, in the direction of the vanes, which then generate the forward counter-thrust airflow.

The flaps are generally pivotingly mounted on the radially internal wall of the reverser mobile cowls, this wall delimiting the secondary flow duct radially outwards. Thus, recesses are provided in this radially internal wall of the reverser cowls in order to receive the sealing flaps in a retracted position, such as adopted in direct jet. However, in direct jet, the presence of the recesses and flaps is a source of aerodynamic disturbances to the secondary flow. Moreover, this presence locally limits the installation of an acoustic panel on the radially internal wall of the reverser cowls.

In order to provide a technical solution to these issues, it has been proposed to replace the flaps by one or more obturator membranes. Such a design is, for example, known in document FR 3 076 864 A1.

However, the solutions proposed with obturator membranes remain improvable, in particular in terms of ease of implementation and ease of deployment, as well as in terms of protecting the acoustic surface attached to the secondary flow duct.

### DISCLOSURE OF THE INVENTION

Firstly, the object of the invention is a thrust reverser for an aircraft propulsion unit, the reverser comprising a fixed structure equipped with a wall internally radially delimiting a secondary flow duct of the propulsion unit intended to be passed through by a secondary flow, the reverser also comprising a mobile structure comprising at least one reverser mobile cowl equipped with a reverser-cowl radially internal wall delimiting the secondary flow duct radially outwardly, the reverser also comprising at least one cascade vane, the mobile structure being translationally movable in relation to the fixed structure along a longitudinal central axis of the reverser, between a forward direct-thrust position and a retreated reverse-thrust position, the thrust reverser also comprising at least one obturator membrane designed to deflect at least some of the secondary flow towards the cascade vane when the mobile structure is in the retreated reverse-thrust position.

According to the invention, the reverser also includes a mobile frame for deploying the obturator membrane, a radially internal edge of the membrane being fixed on this mobile frame pivotingly mounted on the mobile structure of the reverser, the mobile frame being designed to be moved between a retracted position occupied when the mobile structure adopts the forward direct-thrust position thereof, and a position in which it is deployed in the secondary flow duct, occupied when the mobile structure adopts a retreated reverse-thrust position. In addition, in the retracted position of the mobile frame, the latter seals an opening through the radially internal wall of the reverser cowl, this opening being used to deploy the obturator membrane in the secondary flow duct and opening into an internal storage space of the reverser mobile cowl, wherein the membrane is located when the mobile structure adopts the forward direct-thrust position thereof.

Thus, the reverser according to the invention integrates one or more obturator membranes, which provide improved aerodynamic and acoustic performance for the propulsion unit equipped with such a reverser. Indeed, in direct jet, the metal sheet is fitted into the reverser mobile cowl, which makes it possible to have an external secondary flow duct practically free of any parasitic geometric singularity for the drag, and deleterious for the acoustic treatment. Indeed, only the mobile frame for deploying the obturator membrane reconstitutes the secondary flow duct in direct thrust configuration, the surface area of this frame remaining negligible in relation to that encountered in the solutions of the prior art with mobile sealing flaps.

Furthermore, the design specific to the invention offers easy implementation of the obturator membrane, as well as a high reliability for deploying this membrane, through the streamlined deployment kinetics. The mobile frame also makes it possible to reinforce the stability of the membrane, regardless of whether during the deployment thereof, or in the deployed configuration thereof when the mobile structure is in retreated reverse-thrust position.

In addition, it should be noted that the proposed design makes it possible to implement a membrane extending over a high angular sector. The number of membranes and of associated mobile frames can thus remain low within the reverser, for a weight saving.

The invention preferably has at least one of the following optional technical features, either separately or in combination.

According to a preferred embodiment of the invention, the reverser comprises at least one mechanical rotary control member of the mobile frame for deploying the obturator membrane.

Preferably, the mechanical rotary control member includes a first end articulated on the fixed wall internally radially delimiting the secondary flow duct, as well as a second end, opposite the first, articulated on the mobile frame for deploying the obturator membrane, the mechanical control member preferably being a connecting rod. The presence of one or more of these mechanical control members makes it possible, passively, to cause the mobile frame to pivot during the axial movement of the mobile structure between the direct thrust and thrust reverse positions thereof.

According to another preferred embodiment of the invention, the obturator membrane is inflatable, and the reverser is designed so that the membrane adopts a deflated configuration when it is fitted into the internal storage space of the reverser mobile cowl occupying the forward direct-thrust position thereof, and an inflated configuration when it is deployed in the secondary flow duct with the mobile structure in retreated reverse-thrust position.

Preferably, the passage of the membrane from the deflated configuration thereof to the inflated configuration thereof causes the mobile frame to pivot from the retracted position thereof to the position in which it is deployed in the secondary flow duct. This makes it possible to avoid the presence of mechanical control members such as the aforementioned connecting rods, and further decreases the overall weight of the reverser as well as the aerodynamic disturbances in the secondary flow duct.

Preferably, the reverser is designed so that the pivoting of the mobile frame from the retracted position thereof to the deployed position thereof, via a transmission system, an axial movement of the reverser mobile cowl from the forward direct-thrust position thereof to the retreated reverse-thrust position thereof. With such a design where the inflation of the membrane therefore also indirectly causes the axial movement of the reverser mobile cowl, the actuator cylinders of the reverser may advantageously be of the single-effect type, and no longer necessarily of the dual-effect type as is conventionally the case in the prior art. This results in savings in terms of costs and weight.

Regardless of the embodiment envisaged, the obturator membrane is preferably equipped with reinforcing hoops. These hoops not only help to mechanically reinforce the membrane, but they also give it better stability.

Preferably, the mobile frame has a general U-shape, with the two free ends of the U pivotingly mounted on the reverser mobile cowl.

Preferably, the radially internal edge of the membrane also has a general U-shape fixed over the entire length of the U formed by the mobile frame, with a linear connection or a series of adjacent point connections.

The invention also applies just as well to a reverse vane belonging to the fixed structure of the reverser, or to the mobile structure thereof.

Another object of the invention is a nacelle for an aircraft propulsion unit, comprising at least one fan cowl, as well as a thrust reverser as described above.

Finally, another object of the invention is a propulsion unit for an aircraft, comprising a turbomachine and such a nacelle.

Other advantages and features of the invention will become apparent in the non-limiting detailed description below.

### BRIEF DESCRIPTION OF THE DRAWINGS

The following detailed description refers to the accompanying drawings in which:

FIG. 1 is a schematic half-view in longitudinal section of a propulsion unit, comprising a thrust reverser shown in direct thrust configuration;

FIG. 2 is a partial perspective view of the reverser equipping the propulsion unit shown in FIG. 1, with the reverser being in the form of a first preferred embodiment of the invention, and shown in direct thrust configuration;

FIG. 3 is a partial perspective view similar to that of the preceding figure, according to another view angle;

FIG. 4 is a partial perspective view similar to that of FIG. 2, with the reverser shown in reverse thrust configuration;

FIG. 5 is a partial perspective view of the reverser shown in FIG. 4, according to another view angle;

FIG. 6 is a partial perspective view similar to that of FIG. 5, with the reverser mobile cowl having been removed for reasons of clarity;

FIG. 7 is a longitudinal half-sectional view, showing the reverser according to an alternative embodiment, and shown in direct thrust configuration;

FIG. 8 is a longitudinal half-sectional view similar to that of the preceding figure, with the reverser shown in the reverse thrust configuration;

FIG. 9 is a longitudinal half-sectional view, showing the reverser according to another alternative embodiment, and shown in direct thrust configuration;

FIG. 10 is a longitudinal half-sectional view similar to that of the preceding figure, with the reverser shown in the reverse thrust configuration;

FIG. 11 is a schematic longitudinal half-sectional view of the reverser being in the form of a second preferred embodiment of the invention, and shown in direct thrust configuration;

FIG. 12 is a longitudinal half-sectional view similar to that of the preceding figure, with the reverser shown in the reverse thrust configuration;

FIG. 13 is a longitudinal half-sectional view, showing the reverser according to an alternative embodiment, and shown in direct thrust configuration;

FIG. 14 is a longitudinal half-sectional view similar to that of the preceding figure, with the reverser shown in the reverse thrust configuration;

FIG. 15 is a perspective view showing the inflatable membrane of the alternative shown in FIGS. 13 and 14, the membrane being in deflated configuration;

FIG. 16 is a perspective view similar to that of the preceding figure, with the membrane shown in inflated configuration;

FIG. 17 is a perspective view showing a guide rail system of the reverser mobile cowl on a fixed beam of the propulsion unit for integrating the pneumatic supply needed to inflate the membrane;

FIG. 18 is a schematic top view showing another alternative embodiment for the reverser, with the membrane being in deflated configuration;

FIG. 19 is a schematic top view similar to that of the preceding figure, with the membrane shown in inflated configuration;

FIG. 20 is a schematic top view also showing another alternative embodiment for the reverser, this view being similar to that of FIG. 19, and showing the membrane in inflated configuration;

FIG. 21 is a schematic longitudinal half-sectional view of the reverser being in the form of a third preferred embodiment of the invention, and shown in direct thrust configuration;

FIG. 22 is a longitudinal half-sectional view similar to that of the preceding figure, with the reverser shown in the reverse thrust configuration.

### DESCRIPTION OF THE EMBODIMENTS

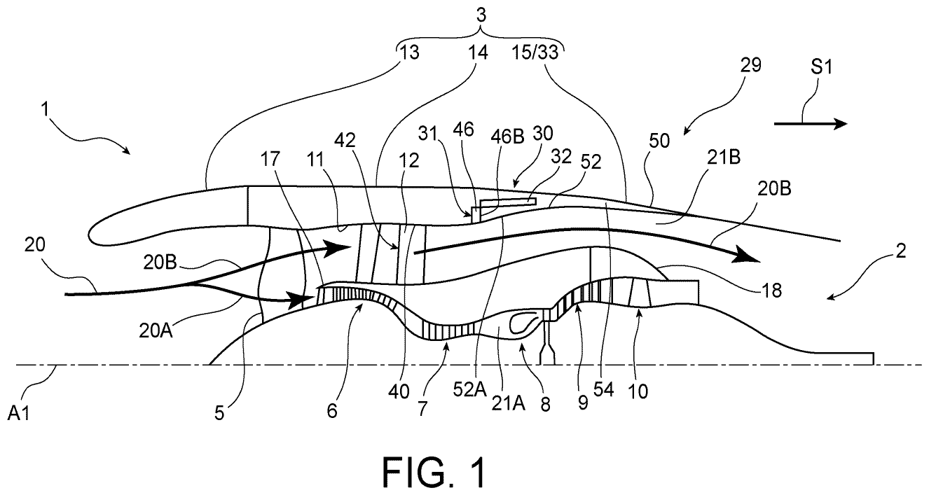

FIG. 1 shows an aircraft propulsion unit 1, having a longitudinal central axis A1.

Hereinafter, the terms “upstream” and “downstream” are defined with respect to a general direction S1 of gas flow through the propulsion unit 1 along the axis A1 when it generates a direct thrust. These terms “upstream” and “downstream” could respectively be replaced by the terms “front” and “rear” with the same meaning.

The propulsion unit 1 comprises a turbomachine 2, a nacelle 3 as well as a pylon (not shown), intended to connect the propulsion unit 1 to a wing (not shown) of the aircraft.

In this example, the turbomachine 2 is a twin-spool turbofan engine comprising, from front to rear, a fan 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbofan engine 2 is provided with a fan casing 11 connected to the gas generator by structural arms 12.

The nacelle 3 comprises a front section forming an air inlet 13, a middle section which includes two fan cowls 14 enveloping the fan casing 11, and a rear section 15.

In operation, an air flow 20 enters the propulsion unit 1 through the air inlet 13, passes through the fan 5 and then splits into a primary flow 20A and a secondary flow 20B. The primary flow 20A flows in a primary gas flow duct 21A passing through the gas generator. The secondary flow 20B flows in a secondary flow duct 21B surrounding the gas generator. The secondary flow duct 21B is delimited radially inwardly by a fixed internal fairing which surrounds the gas generator. In this example, the fixed internal fairing comprises a first portion 17 belonging to the middle section 14, and a second portion 18 extending backwards from the first portion 17, so as to form part of the rear section 15. This second portion 18 forms an integral part of a fixed structure of a thrust reverser which will be described below. This same portion will hereinafter be referred to as the wall 18 internally radially delimiting the secondary flow duct 21B.

Radially outwardly, the secondary flow duct 21B is delimited by the fan casing 11, and, in the configuration shown in FIG. 1, by one or more movable reverser cowls 33 forming part of the rear section 15 of the nacelle 3, and which will be described below. More specifically, between the fan casing 11 and the reverser cowls 33, an outer shell 40 of an intermediate casing 42 is provided, the latter comprising the aforementioned structural arms 12, the radially external end of which is fixed to this shell 40. It therefore also helps delimit the secondary flow duct 21B radially outwardly, being located in the downstream axial extension of the fan casing 11.

The nacelle 3 therefore includes a thrust reverser 30 (shown only schematically and partially in FIG. 1), centred on the axis A1 and comprising, on the one hand, a fixed structure 31 secured to the fan casing 11, and, on the other, a structure 29 that can be moved in relation to the fixed structure 31. The fixed structure 31 includes for example a front frame 46 that fixedly connects it to the fan casing 11, preferably via a knife-edge flange assembly located downstream of the outer shell 11. This front frame 46 contains a profiled aerodynamic part called deflection edge 46B, which guides the flow in reversed jet.

In this preferred embodiment, the fixed structure 31 also includes a plurality of cascade vanes 32 arranged adjacently with one another about the axis A1, in a circumferential direction of the reverser 30 and of the propulsion unit 1. Moreover, the mobile structure 29 comprises for its part, the aforementioned reverser mobile cowls 33, for example two cowls 33 each extending over an angular range of around 180°. This configuration with two cowls 33 is particularly well suited in the case of a nacelle design wherein the cowls/walls 18 are also mounted in an articulated manner, the reverser 30 then having a so-called “D-duct” architecture. In this structure, the cowls 18, 33 are connected so as to open/shut simultaneously during maintenance operations on the engine. However, other structures are possible, such as for example a so-called “C-duct” structure or a so-called “O-duct” structure.

Each reverser cowl 33 includes a radially external internal wall 50 forming a nacelle external aerodynamic surface, as well as a radially internal wall 52, helping to delimit the secondary flow duct 21B radially outwardly. This wall 52 is in the downstream continuity of the deflection edge 46B, in direct thrust configuration. The two walls 50, 52 define a slot 54 axially open at the downstream end of the reverser cowl 33, and wherein at least one part of the vanes 32 are in direct thrust configuration.

FIG. 1 shows the reverser 30 in a forward thrust configuration, called “direct jet”, corresponding to a standard flight configuration. In this configuration, the cowls 33 of the mobile structure 29 are in a closing position, called forward thrust or “direct jet” position, wherein these reverser cowls 33 are bearing on the fixed structure 31, in particular on the deflection edge 46B forming an integral part of the latter. Indeed, in the direct thrust configuration, the upstream end 52A of the radially internal wall 52 of each cowl 33 is axially bearing against the deflection edge 46B.

The mobile structure 29 is thus translationally movable in relation to the fixed structure 31 along the axis A1 of the reverser, between the forward direct-thrust position shown in FIG. 1, and a retreated reverse-thrust position that will be described below. In the forward direct-thrust position of the mobile structure 29, the cascade vanes 32 are arranged in the slot 54 of the reverser cowls 33, by being isolated from the secondary flow duct 21B by the radially internal wall 52 of these sliding cowls 33. This wall 52, forming the external wall of the secondary flow duct, is also called an acoustic internal panel.

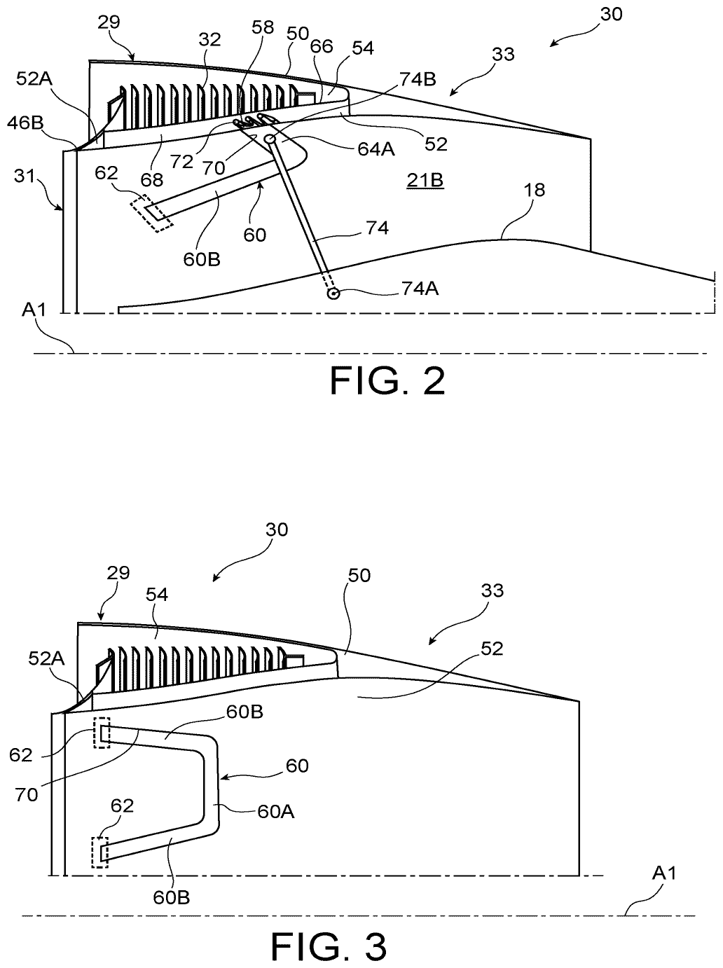

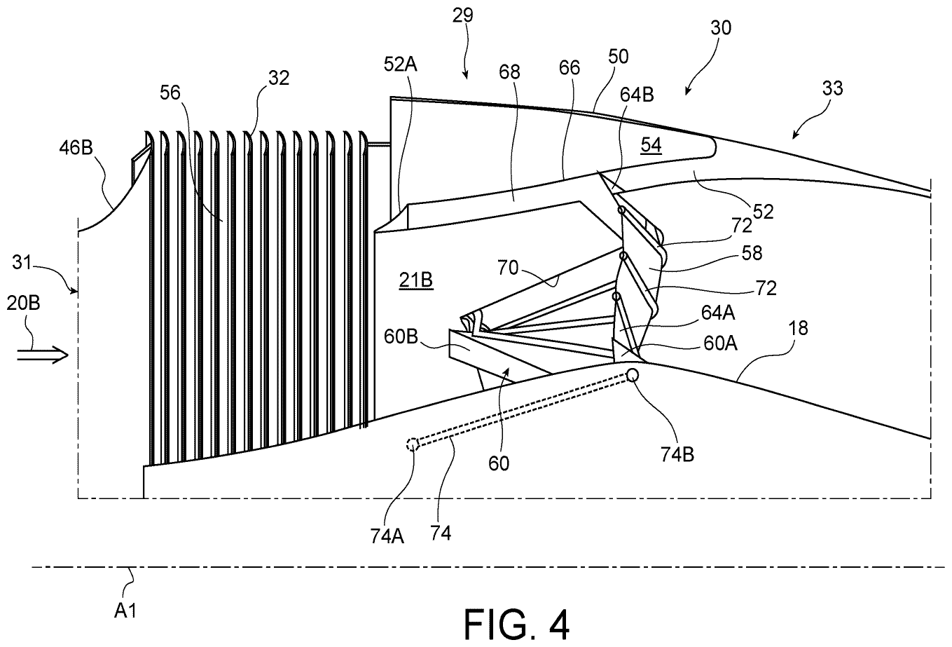

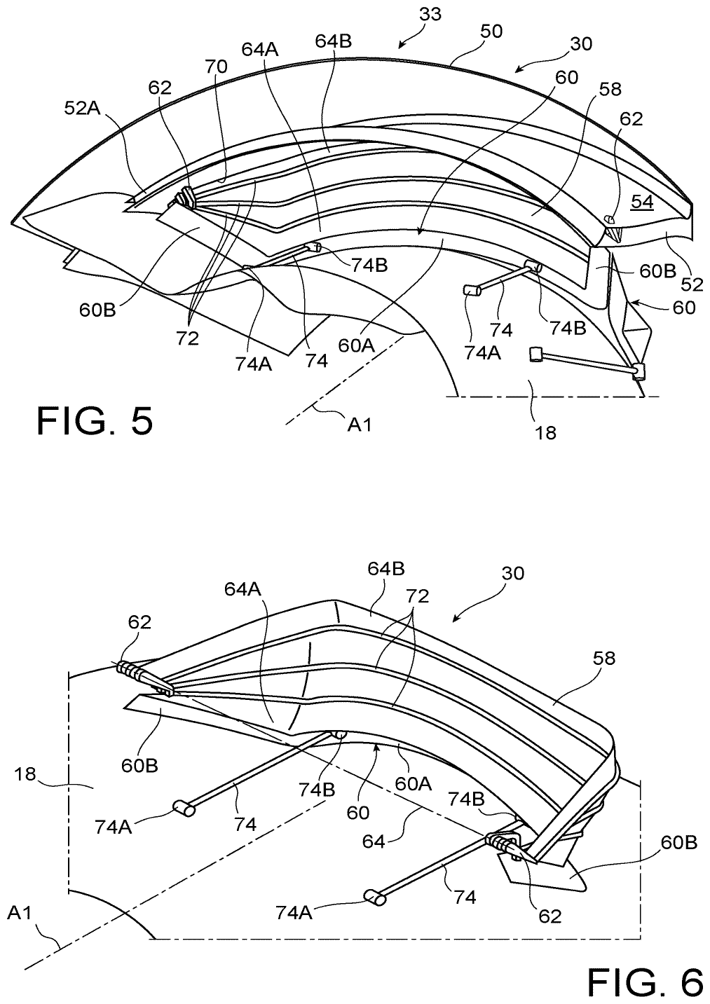

The direct thrust configuration is also shown in FIGS. 2 and 3, whereas the retreated reverse-thrust position of the mobile structure 29 is shown in FIGS. 4 to 6, all of these FIGS. 1 to 6 showing a first preferred embodiment of the present invention. FIG. 4 shows that the recessed internal acoustic panel 52 of the reverser cowls reveals a passage opening 56 upstream in the secondary flow duct 21B, towards the cascade vanes 32. The opening 56 is therefore also delimited upstream by the deflection edge 46B, which flares radially outwardly towards the rear, in order to delimit an air flow intended to pass through the plurality of vanes 32 when the mobile system is in this retreated reverse thrust position. In other words, the deflection edge 46B gradually moves away from the axis A1 from front to rear, in order to guide/deflect the air towards the plurality of vanes 32 in reverse thrust configuration.

In order to deflect at least some of the secondary flow 20B towards the passage opening 56 defined axially between the deflection edge 46B and the upstream end 52A of the radially internal wall 52 of each cowl 33, the reverser 30 includes one or more obturator membranes 58.

Subsequently, a single membrane 58 will be described for each reverser cowl 33. This membrane 58 may extend over a high angular amplitude, for example in the order of 90° to 120°. It should be noted that a plurality of membranes 58 may circumferentially follow on from one another along each cowl. Similarly, only the cooperation between a membrane 58 and the associated cowl 33 thereof will be described below, given that this cooperation is identical or similar for all of the cowls of the reverser 33.

The membrane 58 can be made of a material known to the person skilled in the art for this type of application. For example, it can be a non-impregnated fabric, for example aramid fibres. The membrane 58 may also be made with a composite material the matrix of which is particularly flexible, for example made from aliphatic polyurethane, which makes it possible to use it in different temperature conditions, in particular lower temperatures in the case of a membrane made of aliphatic polyurethane than in the case of a membrane made of silicone. The matrix has a low bending recovery capacity and the resulting structure behaves like a membrane. One of the major properties of this membrane 58 is that it can be folded in a perfectly reversible manner (elastically or by fibres sliding) with a very small radius of curvature in relation to its surface, and that it has a very small thickness, for example in the order of 0.1 to 3 mm. By way of information, it should be noted that this membrane 58 behaves like a boat sail or a parachute/a sail wing when it is put under pressure.

One of the special features of the invention resides in the attachment of the membrane 58 to the reverser 30. For this, and still with reference to FIGS. 1 to 6, a mobile frame 60 is provided for deploying the membrane 58, the frame 60 being pivotingly mounted on the radially internal wall 52 of the reverser mobile cowl 33. Here, the mobile frame 60 preferably has a general U-shape, with a base 60A extending circumferentially according to a curvature identical or similar to that of the radially internal wall 52. Furthermore, the two branches 60B of the U have a substantially axial orientation, here being arranged upstream of the base of the U 60A. The two free ends present on the two branches 60B of the U are pivotingly mounted on the radially internal wall 52, by way of two pivot connections 62 of combined axes 64 (FIG. 6).

A radially internal edge 64A of the membrane 58 also has a general U-shape fixed over the entire length of the U formed by the mobile frame 60, with a linear connection, namely an interrupted over the entire length of these elements 64A, 60 of identical or similar forms. Alternatively, the linear connection may be replaced by a series of adjacent point connections, preferably slightly apart from one another.

The radially internal edge 64A of the membrane 58 is therefore fixed on the pivoting mobile frame 60, whereas a radially external edge 64B is fixed on a part of the mobile structure 29 of the reverser, here preferably on an inner shell 66 of the reverser mobile cowl 33. This shell 66, disposed radially around the radially internal wall 52, defines with an upstream end of the latter an internal space 68 in the thickness of the panel as storage of the membrane 58, in direct thrust configuration. This internal storage space 68, within the reverser mobile cowl 33, is indeed intended to fit the membrane 58 folded on itself, for example in an accordion, when the mobile cowl 33 adopts the forward direct-thrust position thereof as shown in FIG. 2.

Conversely, in the retreated reverse-thrust position, the deployed membrane 58 passes through an opening 70 provided in the radially internal wall 52, and is stretched between the two opposite ends 64A, 64B thereof, as can be seen in FIGS. 4 to 6.

Reinforcing hoops 72 may equip the membrane 58 not only to reinforce the mechanical strength thereof, but also to improve the stability thereof and control the folding thereof. The hoops 72 radially follow on from one another and preferably each have a general U-shape, in accordance with the shape of the membrane 58.

The aforementioned opening 70 also has a general U-shape, complementary to that of the frame 60. Indeed, the mobile frame 60 is designed to adopt a retracted position occupied when the mobile structure 29 adopts the forward direct-thrust position thereof. In this retracted position, the frame 60 seals the opening 70 of complementary shape, reconstituting the flow duct, namely by reconstituting the missing part of the radially internal wall 52. The two pieces are flush, so as to limit the aerodynamic losses on the secondary flow in direct thrust configuration.

This opening 70, which is used to deploy the membrane 58 in the secondary flow duct 21B, therefore opens into the internal storage space 68 of this membrane.

The pivoting frame 60 may thus be moved from the retracted position thereof that has just been described, to a position in which it is deployed in the secondary flow duct 21B, shown in FIGS. 4 to 6 and occupied when the mobile structure 29 adopts the retreated reverse-thrust position thereof. In this deployed position of the mobile frame 60, the latter is pivoted in relation to the radially internal wall 52 of the cowl 33 until the base 60A thereof is in contact or close to the fixed wall 18, so as to seal the secondary flow duct 21B as much as possible.

To obtain the rotation of the deployment mobile frame 60, the reverser here is equipped with connecting rods 74 arranged in the secondary flow duct 21B, and of which a first end 74A is articulated on the fixed wall 18 of the secondary flow duct 21B, and of which a second end 74B opposite the first is articulated on the mobile frame 60, preferably on the base 60A thereof.

With this design, the presence of connecting rods 74 makes it possible, passively, to cause the mobile frame 60 to rotate between the retracted position thereof and the deployed position thereof, during the axial movement of the mobile structure 29 between the direct thrust position thereof and the reverse-thrust position thereof and vice versa.

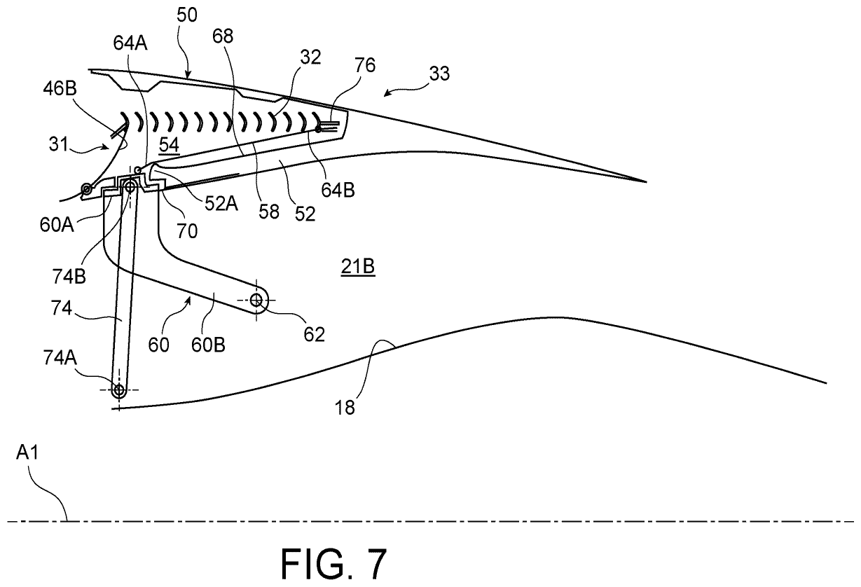

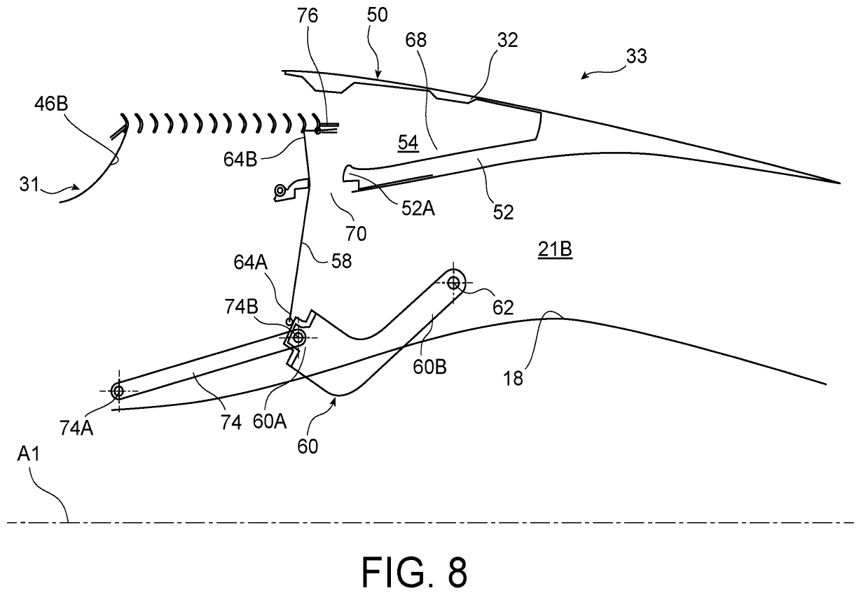

FIGS. 7 and 8 show an alternative embodiment, wherein some modifications are provided in relation to the first preferred embodiment described above. Firstly, the arrangement of the mobile frame 60 in general U-shape is reversed, since the base of the U 60A is upstream of the branches of the U 60B, and no longer downstream. Another difference resides in the fact that in direct thrust configuration shown in FIG. 7, the membrane 58 is not folded on itself, but fitted into the internal storage space 68 that here is formed by a part of the slot 54 of the reverser mobile cowl 33. More precisely, the membrane 58 extends internally along the wall 52. In addition, the radially external edge 64B of the membrane 58 is fixed on a rear vane frame 76, whereas in deployed position of the frame shown in FIG. 8, this stretched membrane passes through the opening 70.

During the movement of the mobile structure towards the forward direct-thrust position thereof, the upstream end 52A of the radially internal wall 52 bears on the membrane 58, and forces it to progressively fit back into the internal storage space 68.

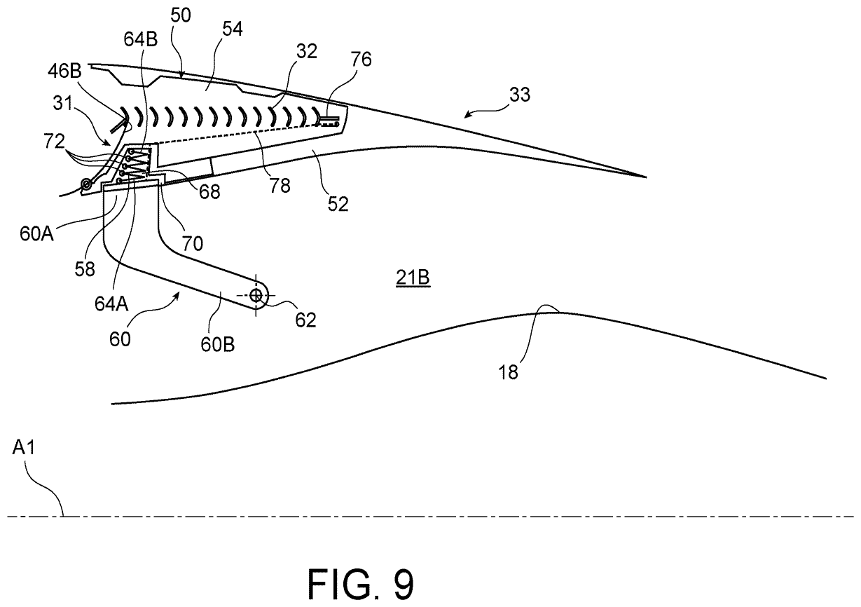

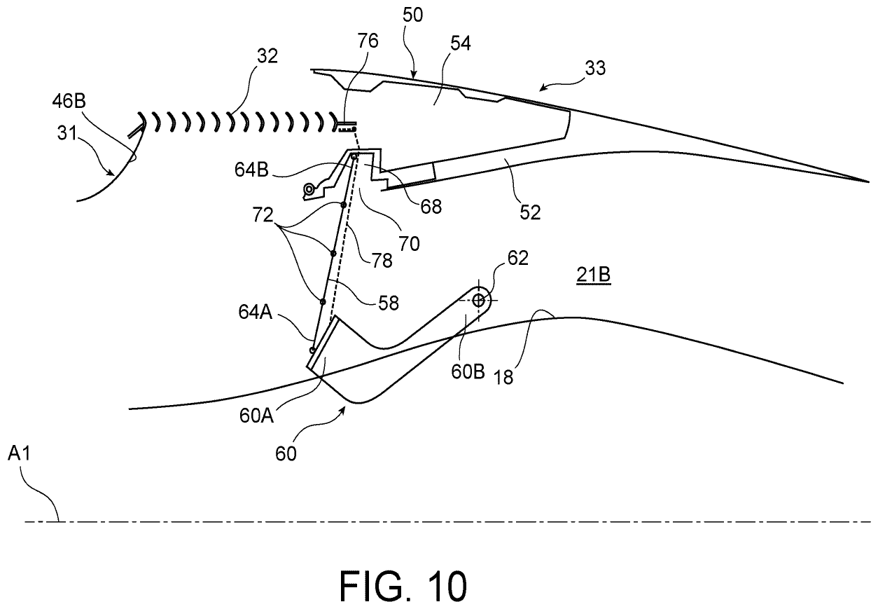

FIGS. 9 and 10 show an alternative embodiment, wherein the rotary connecting rods of the mobile frame are no longer necessary. In this alternative embodiment, firstly, the membrane 58 is fitted into the internal storage space 68 folding on itself, in an accordion. This space 68 is furthermore in the form of an internal cavity made in the front end of the radially internal wall 52. The opening 70 of this space remains sealed by the base 60A of the pivoting frame 60, when the latter adopts the retracted position thereof of FIG. 9. In addition, the radially external edge 64B of the membrane is fixed on a bottom of the cavity 68.

In this alternative embodiment, a cable or a strap 78 connects the rear vane frame 76, to the base 60A of the pivoting frame 60, by being arranged downstream of the membrane 58. During the movement of the mobile structure towards the forward direct-thrust position thereof, the cable 78 progressively forces the membrane 58 to fold back on itself and to fit back into the internal storage space 68. The force generated by this cable 78 on the base 60A makes it possible to rotate the mobile frame 60 towards the retracted position thereof, preferably in combination with elastic return means associated with the pivot connections 62.

It should be noted that in the first preferred embodiment and the alternative embodiments thereof, the membrane 58 in the deployed state takes the form of a hood, with a main central sealing portion extending substantially radially in the secondary flow duct 21B. The main central sealing portion is completed by two lateral sides opposite one another, in the circumferential direction.

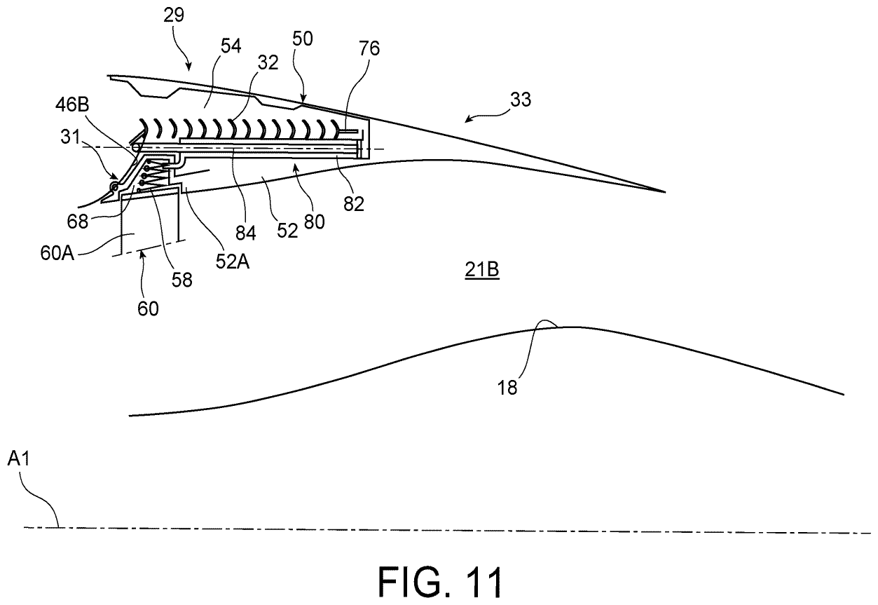

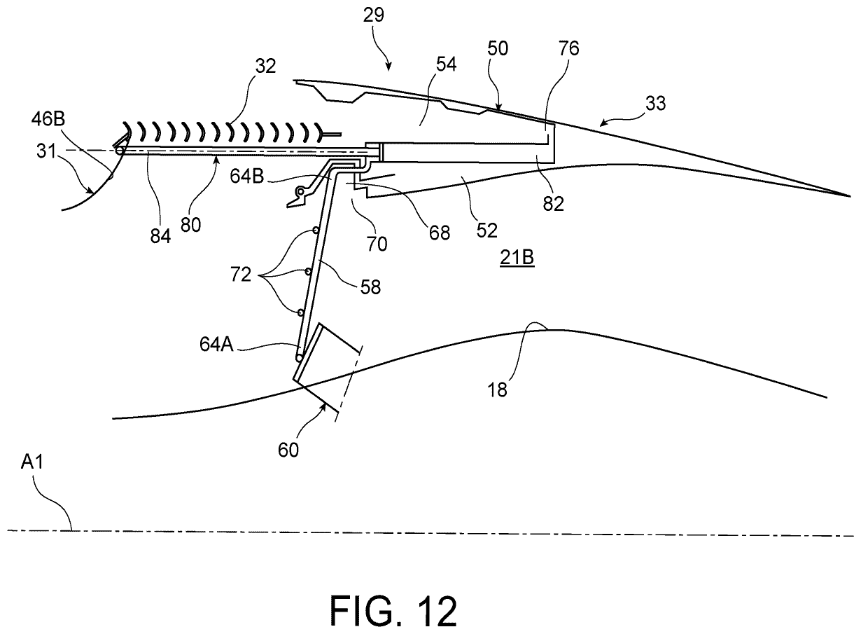

A second preferred embodiment of the invention is shown in FIGS. 11 and 12. This second mode differs from the first mainly in that the obturator membrane 58 has an inflatable character, that is to say that it defines an inner volume alternatively intended to be filled with an inflation fluid, then emptied of this same fluid. In other terms, the inflatable obturator membrane 58 is such that it adopts a deflated configuration of small volume when it is fitted into the internal storage space 68, and that the reverser mobile cowl 33 occupies the forward direct-thrust position thereof of FIG. 11. Furthermore, it adopts an inflated configuration of larger volume when it is deployed in the secondary flow duct 21B, configuration observed when the mobile structure 29 is in the retreated reverse-thrust position of FIG. 12.

Advantageously, the passage of the membrane 58 from the deflated configuration thereof to the inflated configuration thereof causes the mobile frame 60 to pivot from the retracted position thereof to the position in which it is deployed in the secondary flow duct 21B. Indeed, it is the deployment by inflation of the membrane 58 that is used to make the mobile frame 60 pivot towards the deployed position thereof, this frame 60 only being shown schematically in FIGS. 11 and 12 but having an identical or similar design to that described in the first embodiment and the alternative embodiments thereof. In order to pivot in the other direction, namely from the deployed position of the frame 60 to the retracted position thereof, the suction of the inflation fluid is used which pushes the membrane 58 to retract inside the storage space 68, and/or elastic return means associated with the pivot connections connecting this frame to the wall 52 of the mobile cowl 33.

In order to inject the inflation fluid into the inner volume of the membrane 58, and the extraction thereof, any suitable recognised means may be used. For example, in this second preferred embodiment, an inflation cylinder 80 is used of which a mobile part 82 is fixed on the reverser mobile cowl 33, and of which a fixed part 84 is secured to the fixed structure 31 of the reverser. The mobile part 82 here forms the body of the cylinder, whereas the mobile part 84 is formed by the rod of the cylinder. Thus, the radially external edge 64B of the membrane 58 is open for communicating with one of the chambers of the inflation cylinder 80. In this way, when the reverser mobile cowl 33 is axially moved towards the reverse-thrust position thereof, the inflation fluid is flushed from this chamber in the direction of the inner volume in order to inflate it, whereas when the reverser mobile cowl 33 is axially moved towards the direct thrust position thereof, the inflation fluid is sucked into this chamber by being extracted from the inner volume of the membrane.

Consequently, the inflation and the deflation of the membrane 58 occur automatically during the axial movement of the mobile structure 29, performed with conventional reverser actuation cylinders (not shown in FIGS. 11 and 12).

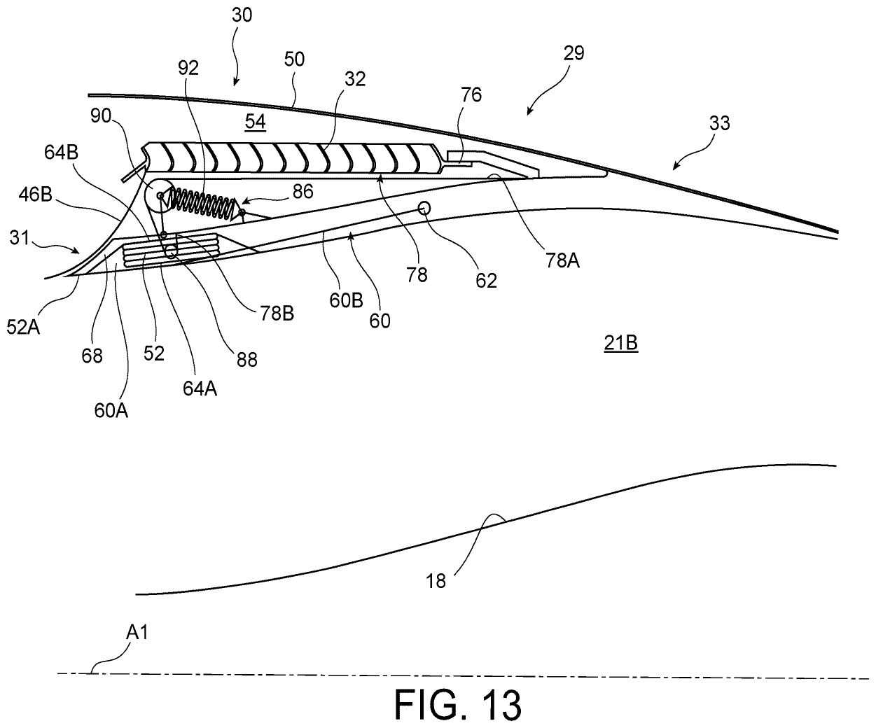

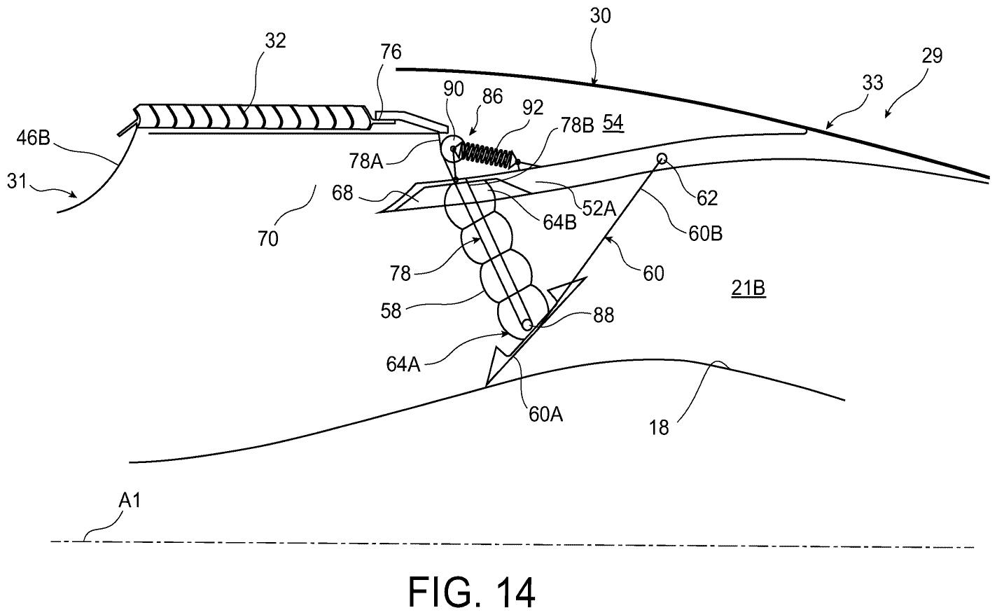

FIGS. 13 and 14 show an alternative embodiment, wherein the inflation and the deflation of the membrane 58 may also be carried out by any means. In this alternative embodiment, the singularity comes from the presence of a transmission system that uses the pivoting of the membrane 58 to cause the axial movement of the reverser mobile cowl 33 from the forward direct-thrust position thereof, to the retreated reverse-thrust position thereof. Indeed, in this alternative embodiment, it is always the deployment by inflation of the membrane 58 that generates the pivoting of the mobile frame 60 towards the position in which it is deployed in the secondary flow duct 21B, as shown in FIG. 14. In addition, the frame 60 cooperates with the transmission system 86, to cause the axial movement of the mobile frame 33 towards the retreated reverse-thrust position. For this, the transmission system 86 comprises the cable or the strap 78, of which a first end 78A is connected to the rear vane frame 76, and of which a second opposite end 78B is fixed in the bottom of the internal storage space 68. From the first end 78A, the cable 78, in direct thrust configuration, extends firstly upstream until contouring the upstream side of a support pulley 90, connected to the wall 52 possibly with a spring damping device 92. After the support pulley 90, the cable 78 passes through the inflatable membrane 58 folded in the internal storage space 68, advancing from the radially external edge 64B to the radially internal edge 64A. Close to the latter, the cable 78 winds around the return pulley 88 fixed on the mobile frame 60, and more precisely on the base 60A thereof. It then advances radially inwardly up to the second end 78B thereof fixed in the internal storage space 68.

Thus, pivoting the mobile frame 60 in the flow duct 21B results in moving the return pulley 88 radially inwardly of this flow duct, and therefore pulling on the cable 78 which, due to the upstream contact thereof with the support pulley 90, forces the latter as well as the assembly of the cowl 33 to move axially downstream. One of the advantages related to this design resides in the possibility of using reverser actuation cylinders no longer of the conventional dual-effect type, but of the single-effect type to only control the axial movement of the mobile structure 29 upstream, in the direction of the forward direct-thrust position thereof and to brake the mobile structure 29 during the opening.

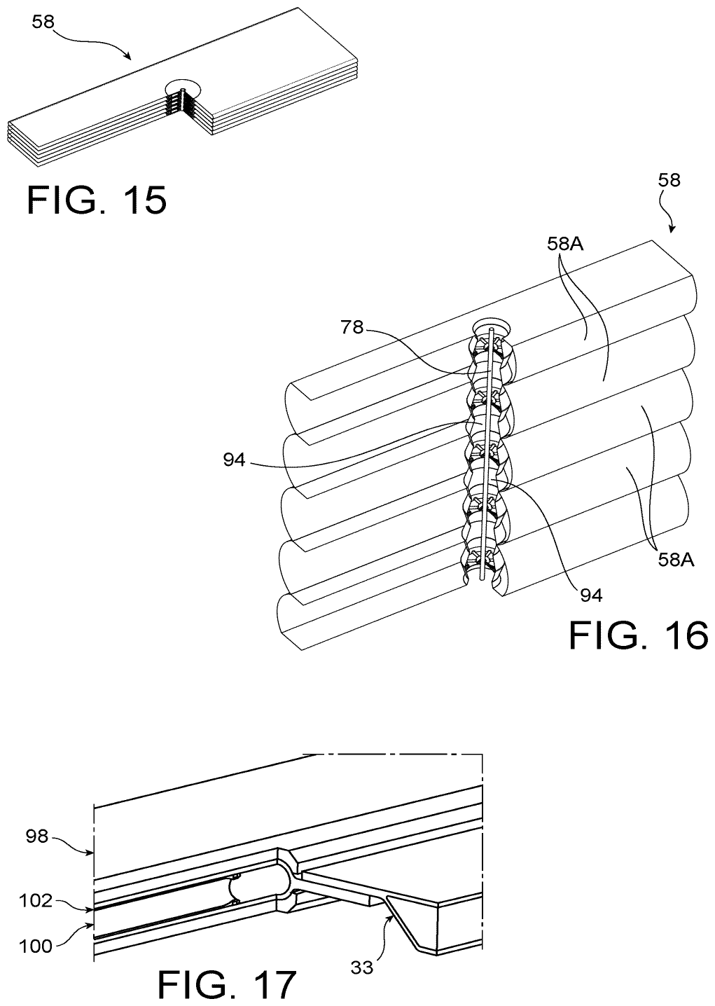

In this respect, it should be noted that in this alternative embodiment, the inflatable membrane 58 may have a so-called flange design, shown in FIGS. 15 and 16. The flanges 58A follow on from one another in the radial direction, and communicate with one another by fluidic communication areas 94, that may be passed through by the cable 78 then helping to fold the membrane 58. In the folded state shown in FIG. 15, the flanges 58A are flat and stacked on top of one another, considerably limiting the size of the deflated membrane.

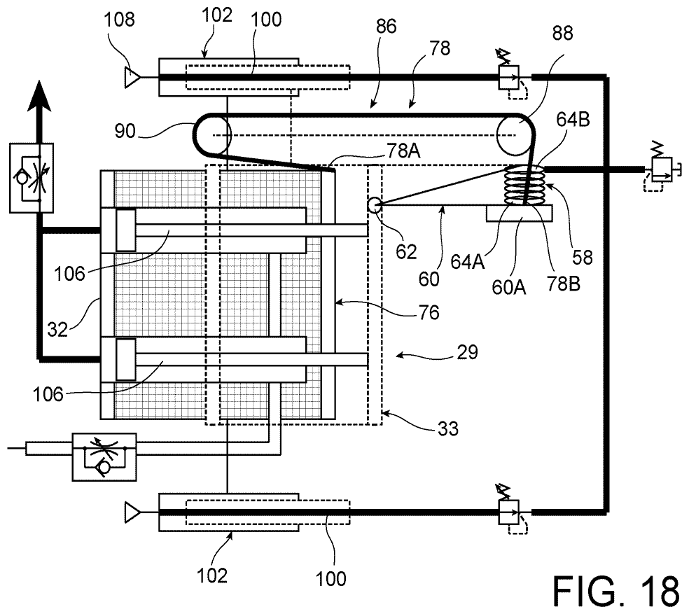

As indicated above, the inflation fluid may be injected into the membrane 58, and extracted therefrom, by any means. For example, with reference to FIG. 17, a conduit 100 may be provided through a guide rail system 102 making it possible to axially slide the reverser mobile cowl 33 along a fixed beam 98 of the propulsion unit. This conduit 100 is therefore obtained by the hollow character of one of the elements of the guide rail system 102, through which the inflation fluid may flow in the direction of, and/or from, the inflatable membrane 58.

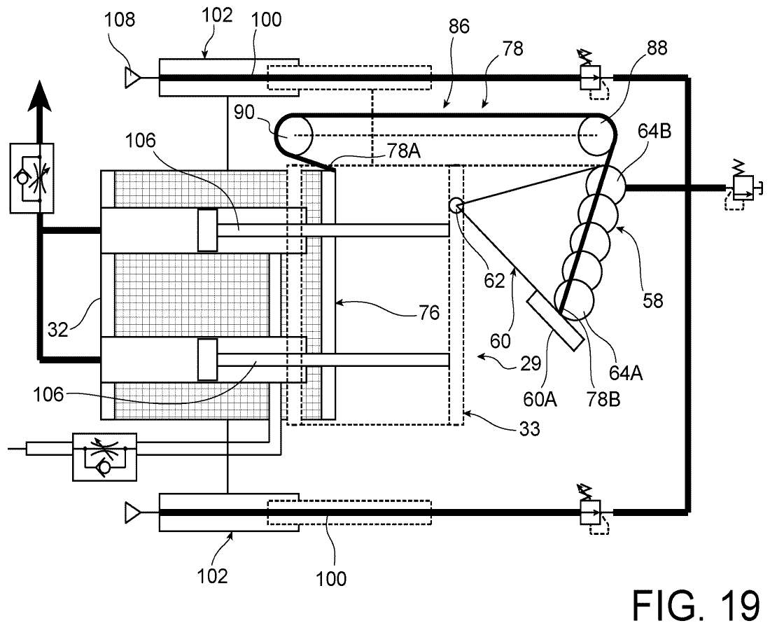

Another alternative embodiment is shown in FIGS. 18 and 19, using the guide rail system 102 to define through the latter conduits 100 for passing through the inflation fluid, communicating with the open radially external edge 64B of the inflatable membrane 58. Upstream, these conduits 100 also communicate with any source 108 of inflation fluid.

In this alternative embodiment, the transmission system 86 is also provided with the support pulley 90 thereof and the return pulley thereof, both fixed on the reverser mobile cowl 33 only shown schematically, and with the cable 78 thereof cooperating with the aforementioned pulleys. The second end 78B of the cable 78 is connected directly on the base 60A of the mobile frame 60.

The principles disclosed above remain applicable for this alternative embodiment, in particular the fact of generating the rotation of the mobile frame 60 by inflating the membrane, or also driving the mobile cowl 33 downstream by way of the transmission system 86, the cable of which 78 bearing on the pulley 90 is pulled radially inwardly due to the rotation of the mobile frame 60 towards the position in which it is deployed in the secondary flow duct.

In this alternative embodiment, the single-effect actuation cylinders 106 have been shown for the movement downstream of the mobile structure 29, these cylinders being for example hydraulic, or also electric.

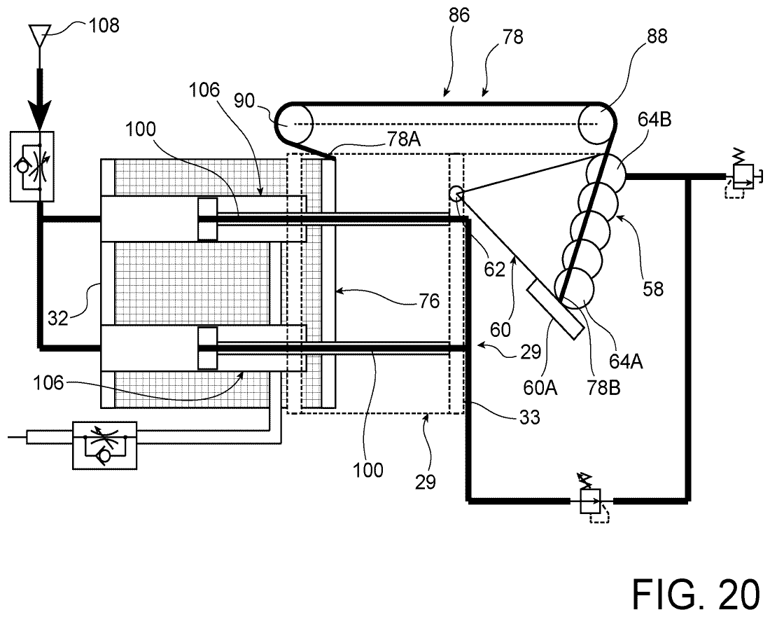

A similar alternative embodiment is shown in FIG. 20, wherein the conduits 100 for circulating the inflation fluid are at present produced through the rods of the actuation cylinders 106 of the reverser. One of the chambers of these cylinders 106 is thus occupied by the inflation fluid that is used indirectly to move the mobile structure 29 towards the retreated reverse-thrust position thereof, whereas the other cylinder chamber is occupied by the actuation fluid making it possible to return the mobile structure 29 to the forward direct-thrust position thereof. This particular functionalisation of the actuation cylinders 106 contributes to reducing the overall size of the reverser.

In order to ensure such a reduction of the overall size of the reverser, another solution (not shown) consists in replacing the cable 78 with a hose through which the inflation fluid is able to flow. This mainly contributes to reducing all of the pipework within the reverser, for a savings in weight, in cost, and in size.

Finally, it should be noted that all of the designs that have been described above relate to fixed-vane reverser architectures, but that they may each be suitable for a mobile-vane architecture.

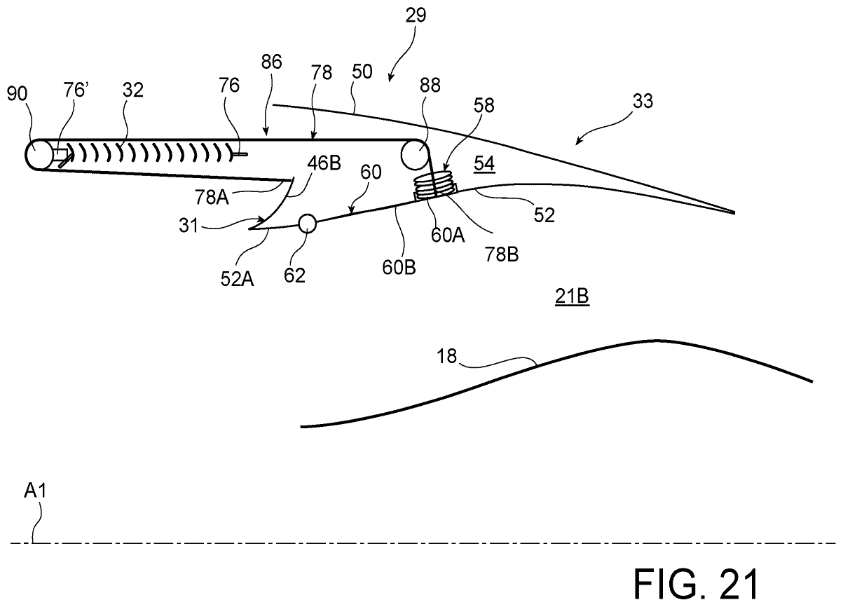

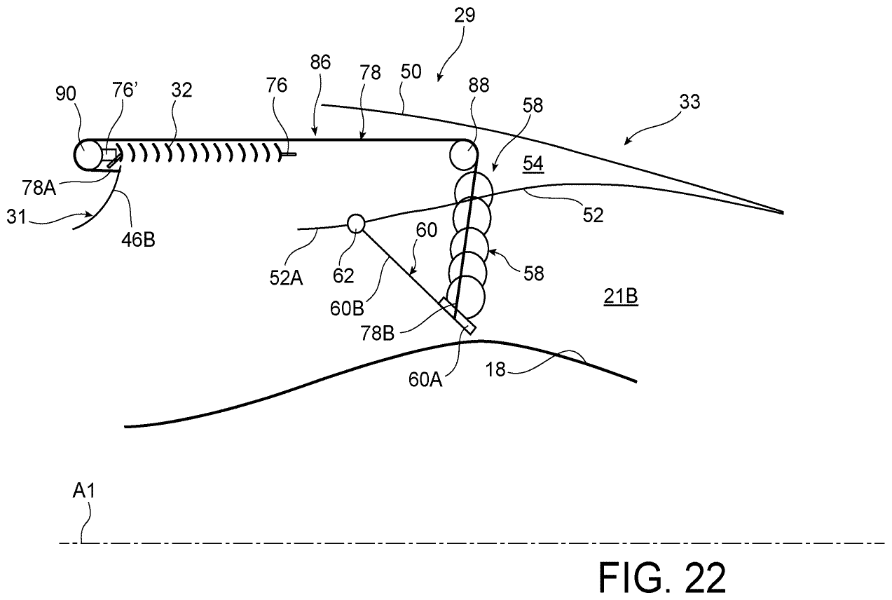

For example, in the third preferred embodiment of the invention shown in FIGS. 21 and 22, the first end 78A of the cable 78 is fixed on the fixed structure 31 close to or on the deflection edge 46B. The support pulley 90 is fixed on the front vane frame 76′, and the second end 78B of the cable 78 is fixed on the base 60A of the mobile frame 60. Here, inflating the membrane 58 causes the frame 60 to pivot, which pulls on the cable 78 radially inwardly resulting with the bearing thereof on the pulley 90, which leads the assembly of the mobile structure 29, including the vanes 32, to move downstream towards the retreated reverse-thrust position.

Various modifications may be made by a person skilled in the art to the invention that has just been described, by way of non-limiting examples only, the scope of which is defined by the appended claims. For example, the thrust reverser 30 can alternatively have a “C-duct” or “O-duct” structure. In addition, all of the features disclosed above, in the various preferred embodiments of the invention and their alternative embodiments, can be combined together. Moreover, it should be noted that all of the figures that have been described above, the elements that bear the same numerical references correspond to identical or similar elements.

1. A thrust reverser for an aircraft propulsion unit, the reverser comprising a fixed structure equipped with a wall internally radially delimiting a secondary flow duct of the propulsion unit intended to be passed through by a secondary flow, the reverser also comprising a mobile structure comprising at least one reverser mobile cowl equipped with a reverser-cowl radially internal wall delimiting the secondary flow duct radially outwardly, the reverser also comprising at least one cascade vane, the mobile structure being translationally movable in relation to the fixed structure along a longitudinal central axis of the reverser, between a forward direct-thrust position and a retreated reverse-thrust position, the thrust reverser also comprising at least one obturator membrane designed to deflect at least some of the secondary flow towards the cascade vane when the mobile structure is in the retreated reverse-thrust position,
wherein the thrust reverser also includes a mobile frame for deploying the obturator membrane, a radially internal edge of the membrane being fixed on this said mobile frame pivotingly mounted on the mobile structure of the reverser, the mobile frame being designed to be moved between a retracted position occupied when the mobile structure adopts the forward direct-thrust position thereof, and a position in which it is deployed in the secondary flow duct, occupied when the mobile structure adopts the retreated reverse-thrust position thereof,
and in the retracted position of the mobile frame, the latter seals an opening through the radially internal wall of the reverser cowl, said opening being used to deploy the obturator membrane in the secondary flow duct and opening into an internal storage space of the reverser mobile cowl, wherein the membrane is located when the mobile structure adopts the forward direct-thrust position thereof.

2. The thrust reverser according to claim 1, wherein the thrust reverser comprises at least one mechanical rotary control member of the mobile frame for deploying the obturator membrane.

3. The thrust reverser according to claim 2, wherein the mechanical rotary control member includes a first end articulated on the fixed wall internally radially delimiting the secondary flow duct, as well as a second end, opposite the first, articulated on the mobile frame for deploying the obturator membrane, the mechanical control member being a connecting rod.

4. The thrust reverser according to claim 1, wherein the obturator membrane is inflatable, and the reverser is designed so that the membrane adopts a deflated configuration when it is fitted into the internal storage space of the reverser mobile cowl occupying the forward direct-thrust position thereof, and an inflated configuration when it is deployed in the secondary flow duct with the mobile structure in retreated reverse-thrust position.

5. The thrust reverser according to claim 4, wherein the thrust reverser is designed so that the passage of the membrane from the deflated configuration thereof to the inflated configuration thereof causes the mobile frame to pivot from the retracted position thereof to the position in which it is deployed in the secondary flow duct.

6. The thrust reverser according to claim 5, wherein the thrust reverser is designed so that the pivoting of the mobile frame from the retracted position thereof to the deployed position thereof causes, via a transmission system, an axial movement of the reverser mobile cowl from the forward direct-thrust position thereof to the retreated reverse-thrust position thereof.

7. The thrust reverser according to claim 1, wherein the mobile frame has a general U-shape, with the two free ends of the U pivotingly mounted on the reverser mobile cowl.

8. The thrust reverser according to claim 7, wherein the radially internal edge of the membrane also has a general U-shape fixed over the entire length of the U formed by the mobile frame, with a linear connection or a series of adjacent point connections.

9. A nacelle for an aircraft propulsion unit, comprising at least one fan cowl, as well as a thrust reverser according to claim 1.

10. A propulsion unit for an aircraft, comprising a turbomachine and a nacelle according to claim 9.
